(19) United States
(12) Patent Application Publication
(10) Pub. No.: US 2024/0164538 A1
(43) Pub. Date: May 23, 2024

(54) MATTRESS ASSEMBLY AND METHOD OF USE

(71) Applicant: Azyok LLC, Austin, TX (US)

(72) Inventors: Jasmine Choksi, Austin, TX (US); John Ramseier, Austin, TX (US); Bartek Zalewski, Newmarket (CA)

(73) Assignee: Azyok LLC, Austin, TX (US)

(21) Appl. No.: 17/991,513

(22) Filed: Nov. 21, 2022

(51) Int. Cl. A47C 27/08; A47C 31/00

(52) U.S. Cl. CPC A47C 27/082; A47C 31/00; A61G 7/05723

(57) ABSTRACT

A mattress for use during recovery from buttock surgery includes a first wall and opposed second wall, a peripheral wall, and an interior wall extending between the first wall and second wall, with the interior wall being spaced inwardly from the peripheral wall. A bore bounded and defined by the interior wall has a first opening defined in the first wall and a second opening defined in the second wall. The first opening is of a first dimension and the second opening is of a different second dimension. In particular, the first opening is larger than the second opening. A cup holder is provided in each of the first wall and the second wall. A first pocket is provided on a first side of the mattress and a second pocket is provided on a second side of the mattress. The first pocket is inverted relative to the second pocket.

### TECHNICAL FIELD

This disclosure is directed to mattresses. More specifically, this disclosure relates to mattresses which are only utilized in particular situations. In particular, the present disclosure is directed to a mattress which may be utilized by a patient after undergoing gluteoplasty. Specifically, the mattress defines a bore which extends from a first wall of the mattress through to a second wall thereof. A first opening to the bore defined in the first wall is larger than a second opening to the bore defined in the second wall.

### BACKGROUND OF THE INVENTION

Gluteoplasty is a surgical procedure in which the shape and/or size of a person's buttocks is changed to correct defects or to aesthetically enhance the appearance of the person's buttocks. One type of gluteoplasty which has recently become very popular is a buttocks enhancement procedure known as a Brazilian Butt Lift (BBL). During a BBL gluteoplasty, fat is removed from one part of the person's body by way of liposuction and then the fat is transferred during a plastic surgery procedure to the person's buttocks in order to augment the shape and size of the buttocks. BBL gluteoplasty typically does not involve the insertion of artificial implants into the buttocks. However, in other gluteoplasty procedures, implants other than fat may be utilized.

After a BBL procedure or after other types of gluteoplasty, the patient may experience substantial pain and discomfort as they heal. Patients are typically required to avoid sitting or sleeping on their back or sides for as long as eight to ten weeks. Obviously, these restrictions make it difficult for a patient to be comfortable for any period of time.

A variety of aids have been proposed in the prior art to help a patient recover more comfortably from BBL surgery. These aids include contoured pillows upon which a patient can sit without placing undue pressure on their buttocks. Inflatable pillows which include a central bore for the buttocks are also proposed by the prior art. A variety of inflatable mattresses are also proposed by the prior art. Some of the inflatable mattresses define a bore for receiving the buttocks therein. One of the issues that is experienced by users of inflatable mattresses and pillows which define a bore therein for the buttocks, is that the bore is of a particular size. The size of the bore may be too small for some patients and too large for other patients. In the case of the bore being too large, patients are frequently instructed to place some type of additional obstructive object, like a pillow, into the bore to stop the person from sinking too low into the bore and thereby placing an unnecessary strain on their body.

### SUMMARY OF THE INVENTION

A mattress for use during recovery from buttock surgery includes a first wall and opposed second wall, a peripheral wall, and an interior wall extending between the first wall and second wall, with the interior wall being spaced inwardly from the peripheral wall. A bore bounded and defined by the interior wall has a first opening defined in the first wall and a second opening defined in the second wall. The first opening is of a first dimension and the second opening is of a different second dimension. In particular, the first opening is larger than the second opening. A cup holder is provided in each of the first wall and the second wall. A first pocket is provided on a first side of the mattress and a second pocket is provided on a second side of the mattress. The first pocket is inverted relative to the second pocket.

In one aspect, an exemplary embodiment of the present disclosure may provide a mattress for recovery after surgery, said mattress comprising a first wall and an opposed second wall spaced from the first wall; a peripheral wall extending between a perimeter of the first wall and a perimeter of the second wall; an interior wall extending between a region of the first wall and a region of the second wall, wherein the interior wall is spaced inwardly from the peripheral wall; a bore bounded and defined by the interior wall; a first opening to the bore defined in the first wall; a second opening to the bore defined in the second wall; and wherein the first opening is of a first dimension and the second opening is of a second dimension, and the second dimension differs from the first dimension.

In one embodiment, the first opening is larger than the second opening. In one embodiment, the bore may be elliptical or generally elliptical in shape when viewed from above or from below. In one embodiment, the bore may be rectangular or generally rectangular in shape when viewed from above or from below. In one embodiment, the bore may be circular or generally circular in shape when viewed from above or from below. In one embodiment, the bore may be square or generally square in shape when viewed from above or from below.

In one embodiment, the mattress may further comprise a cup holder defined in the first wall. In one embodiment, the mattress may further comprise a cup holder defined in the second wall. In one embodiment, the peripheral wall may include a first side and an opposed second side which define a lateral direction therebetween; and wherein the mattress may further comprise a first pocket provided on an exterior surface of the first side. In one embodiment, the mattress may further comprise a second pocket provided on an exterior surface of the second side. In one embodiment, the second pocket may be inverted relative to the first pocket. In one embodiment, an opening to the first pocket may be accessible from a direction moving from the first wall towards the second wall. In one embodiment, an opening to the second pocket may be accessible from a direction moving from the second wall towards the first wall.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top, front, left side isometric perspective view of a first embodiment of a mattress in accordance with the present disclosure;

FIG. 2 is a bottom, rear, left side isometric perspective view of the mattress of FIG. 1;

FIG. 3 is a top plan view of the mattress of FIG. 1;

FIG. 4 is a bottom plan view of the mattress of FIG. 1;

FIG. 5 is a left side elevation view of the mattress of FIG. 1;

FIG. 6 is a right side elevation view of the mattress of FIG. 1;

FIG. 7 is a front elevation view of the mattress of FIG. 1;

FIG. 8 is a rear elevation view of the mattress of FIG. 1;

FIG. 9 is a longitudinal cross-section of the mattress taken along line 9-9 of FIG. 3 showing the dimensions of the aperture;

FIG. 9A is a longitudinal cross-section of the mattress taken along line 9A-9A of FIG. 3;

FIG. 9B is a longitudinal cross-section of the mattress taken along line 9B-9B of FIG. 3;

FIG. 10 is a lateral cross-section of the mattress taken along line 10-10 of FIG. 3 showing the dimensions of the aperture;

FIG. 10A is a lateral cross-section of the mattress taken along line 10A-10A of FIG. 3;

FIG. 10B is a lateral cross-section of the mattress taken along line 10B-10B of FIG. 3;

FIG. 11 is a longitudinal cross-section of the mattress similar to FIG. 9 and showing a person resting on the mattress with their buttocks received in the first opening to the bore; and

FIG. 12 is a longitudinal cross-section of the mattress similar to FIG. 9 and showing a person resting on the mattress with their buttocks received in the second opening to the bore;

FIG. 13 is a top plan view of a second embodiment of a mattress in accordance with the present disclosure;

FIG. 14 is a longitudinal cross-section of the mattress taken along line 14-14 of FIG. 13;

FIG. 15 is a lateral cross-section of the mattress taken along line 15-15 of FIG. 13;

FIG. 16 is a top plan view of a third embodiment of a mattress in accordance with the present disclosure;

FIG. 17 is a longitudinal cross-section of the mattress taken along line 17-17 of FIG. 16;

FIG. 18 is a lateral cross-section of the mattress taken along line 18-18 of FIG. 16;

FIG. 19 is a top plan view of a fourth embodiment of a mattress in accordance with the present disclosure;

FIG. 20 is a longitudinal cross-section of the mattress taken along line 20-20 of FIG. 19;

FIG. 21 is a lateral cross-section of the mattress taken along line 21-21 of FIG. 19;

FIG. 22 is a top plan view of a fifth embodiment of a mattress in accordance with the present disclosure;

FIG. 23 is a longitudinal cross-section of the mattress taken along line 23-23 of FIG. 22;

FIG. 24 is a lateral cross-section of the mattress taken along line 24-24 of FIG. 22.

Similar numbers refer to similar parts throughout the drawings.

### DETAILED DESCRIPTION

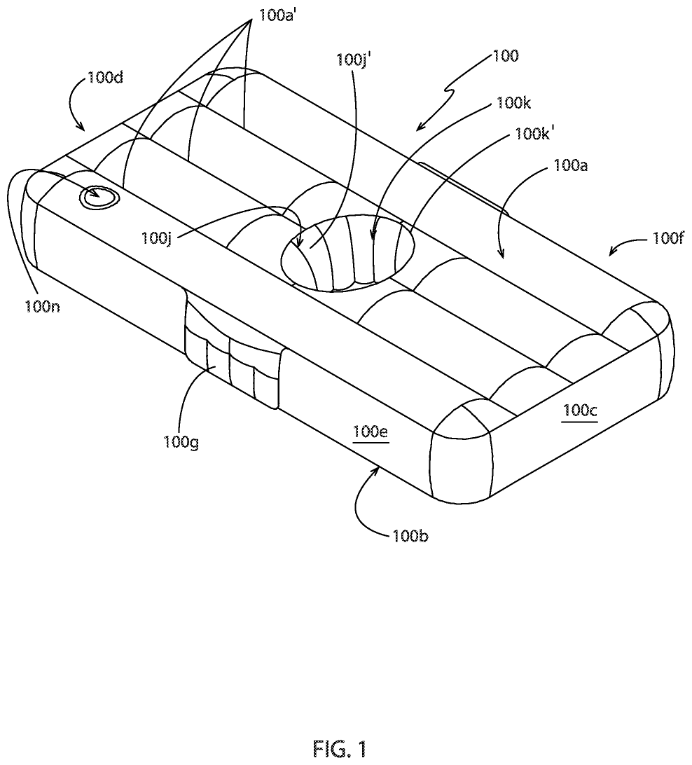

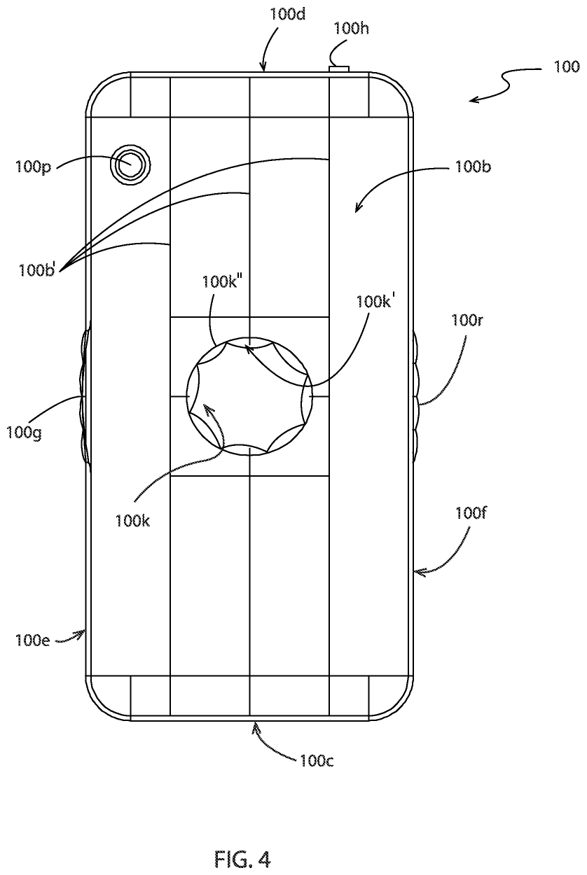

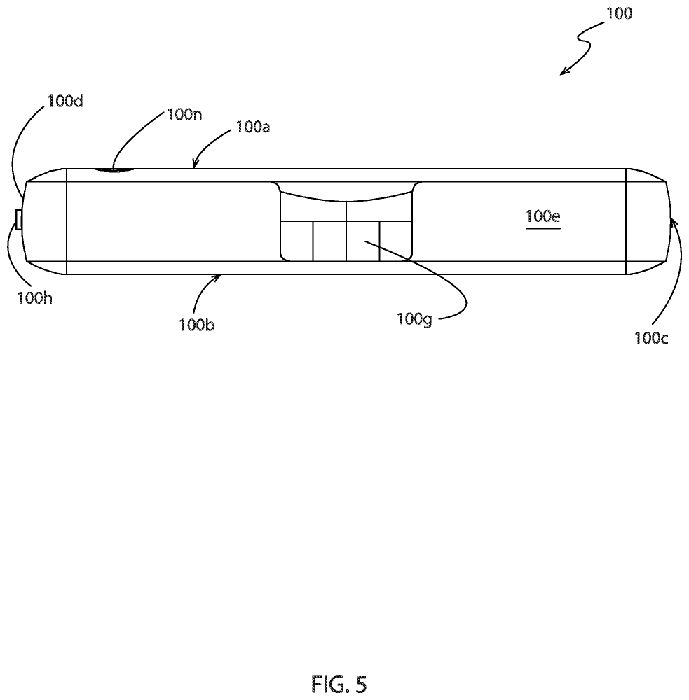

Referring to FIGS. 1-10 there is shown a mattress in accordance with an aspect of the present disclosure, generally indicated at 100. Mattress 100 is preferably an inflatable mattress and all of the figures provided herewith show mattress 100 in an inflated condition. It will be understood however, that mattress 100 may be moved from an inflated condition to a deflated condition where the mattress 100 may be folded up for storage purposes.

Mattress 100 includes a first wall 100a and an opposed second wall 100b, a first end 100c and an opposed second end 100d, a first side 100e and an opposed second side 100f. First wall 100a and second wall 100b define a vertical direction therebetween; first end 100c and second end 100d define a longitudinal direction therebetween, and first side 100e and second side 100f define a lateral or transverse direction therebetween. First end 100c, second end 100d, first side 100e, and second side 100f form a peripheral wall which extends between a perimeter of the first wall 100a and a perimeter of the second wall 100b. In one embodiment, mattress 100 is movable between a collapsed condition and an expanded condition. In the collapsed condition, an interior surface of first wall 100a is located adjacent an interior surface of second wall 100b. In the collapsed condition the interior surface of first wall 100a may abut the interior surface of the second wall 100b. In the expanded condition the interior surface of first wall 100a is spaced a distance away from the interior surface of the second wall 100b such that the interior surfaces of the first and second walls 100a, 100b are remote from one another and cannot abut one another. In one embodiment, the mattress 100 is movable between the collapsed condition and the expanded condition by inflating the mattress 100, as will be described later herein.

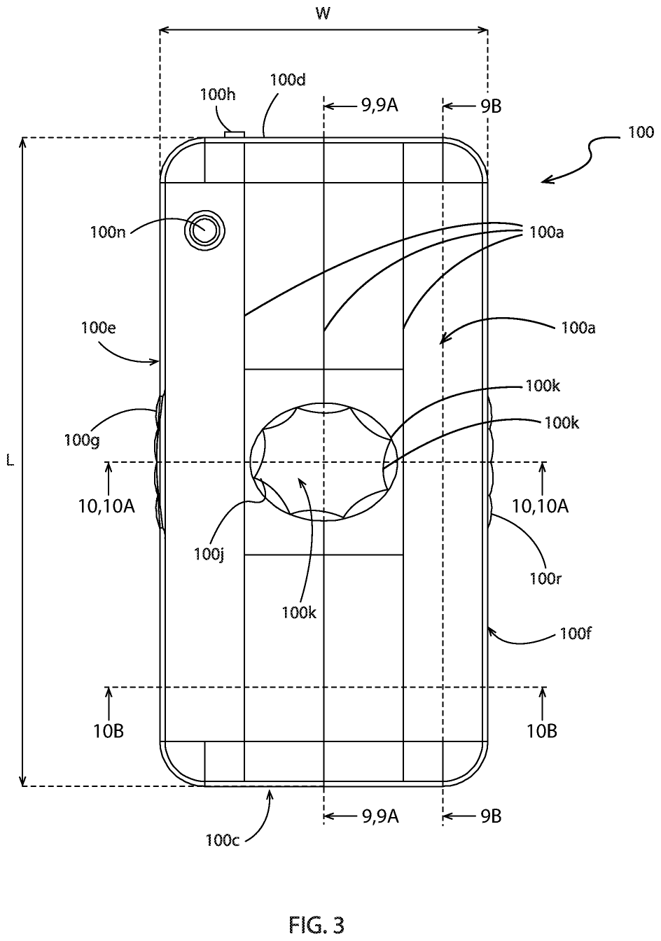

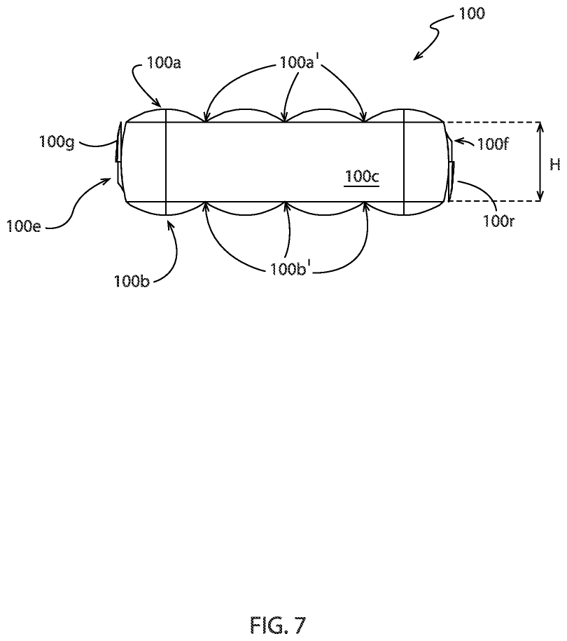

In one embodiment and as illustrated in the attached figures, mattress 100 is generally a rectangular cuboid in shape. As shown in FIGS. 3 and 7, mattress has a length “L”, a width “W”, and a height “H”. In one embodiment, the length “L” is about 76 inches, the width “W” is about 38 inches, and the height “H”, is about 12.6 inches. It will be understood that in other embodiments, the length “L”, width “W”, and height “H” may be different. It should further be understood that in other embodiments, mattress 100 may be of a different configuration other than a rectangular cuboid.

Mattress 100 may be fabricated from any suitable material including, but not limited to, Polyvinyl Chloride (PVC). Seams (not numbered) connect the various walls of the mattress to one another. The seams are constructed in any suitable manner which will ensure air will not tend to leak out of the mattress once inflated. For example, the seams may be formed by heat sealing overlapping regions of the various walls to one another. The seams may also be reinforced in any suitable manner, such as by stitching.

In one embodiment, flocking may be provided on the exterior surface of at least first wall 100a and second wall 100b, and preferably also on the exterior surfaces of first end 100c, second end 100d, first side 100e, and second side 100f. In one embodiment, the flocking is made of nylon or a mucinous fluff. The flocking is soft to the touch and is breathable, helping to ensure that the skin of a person laying on the mattress 100 does not tend to stick to the mattress material. The flocking thereby helps the person to comfortably adjust the position of their body on the mattress while resting or sleeping.

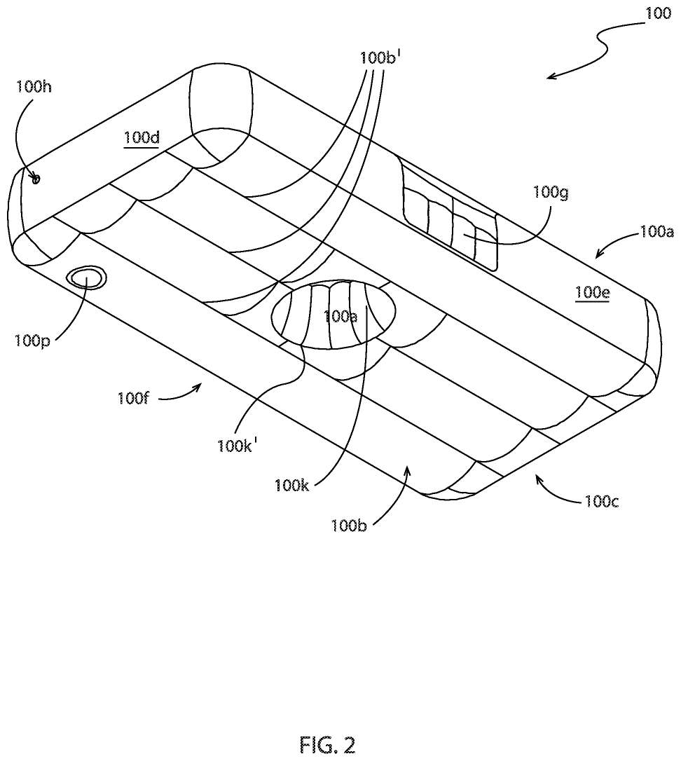

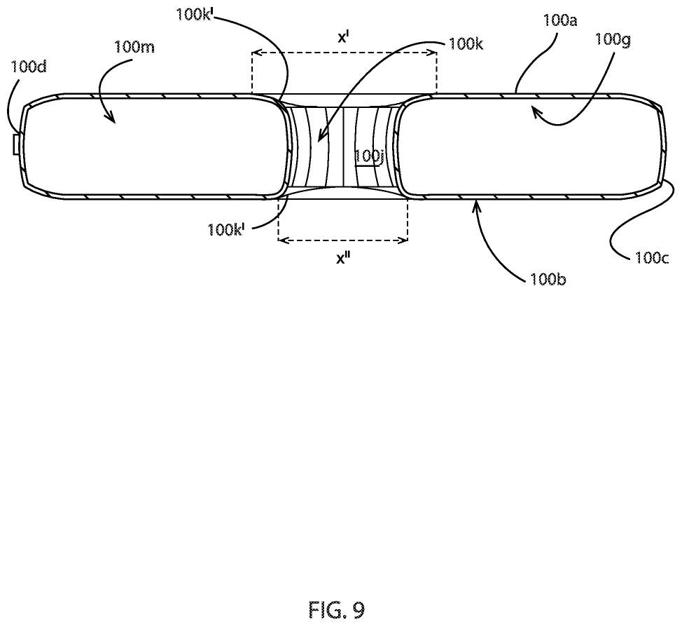

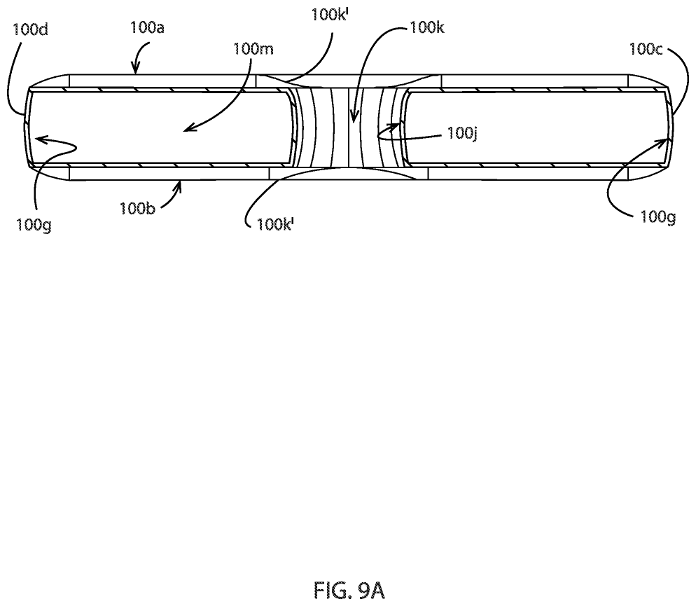

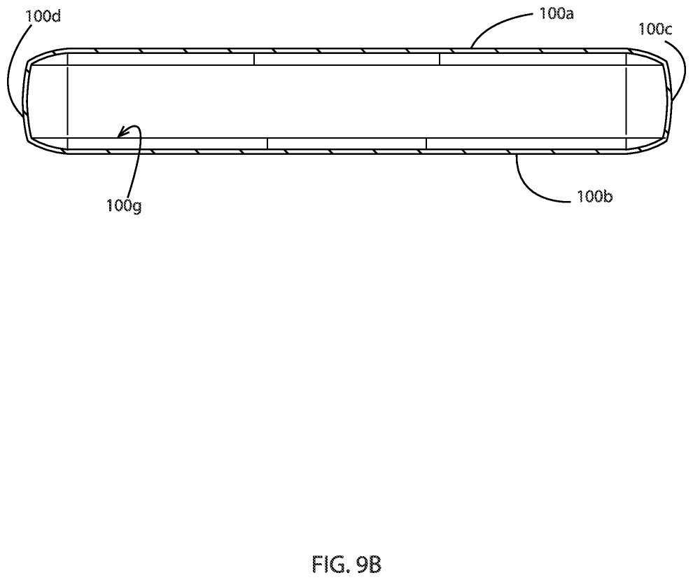

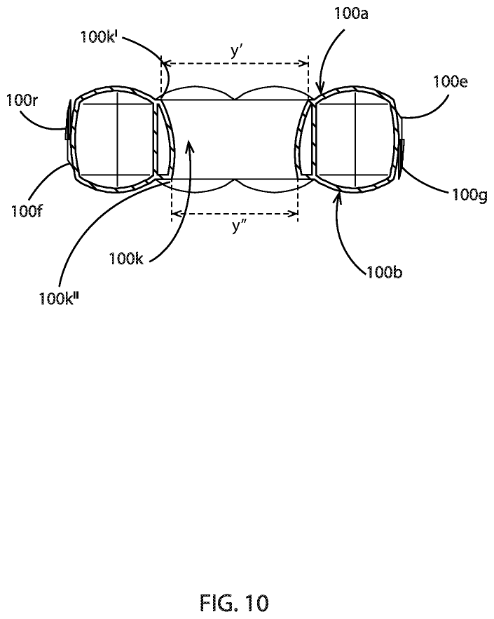

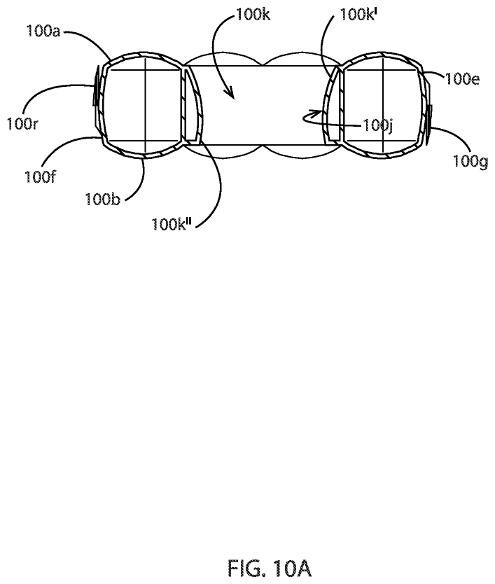

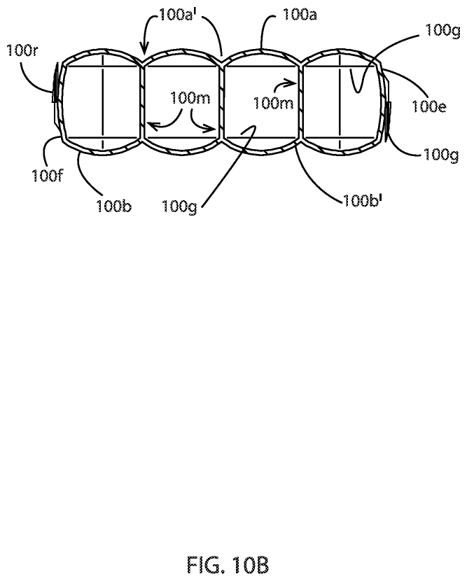

Referring to FIGS. 9 and 10, first wall 100a, second wall 100b, first end 100c, second end 100d, first side 100e, and second side 100f bound and define an interior chamber 100g. At least one access port is provided on mattress 100 to enable a user to inflate and/or deflate mattress 100, as will be later described herein. By way of example only a single access port 100h (FIG. 2) is illustrated as being provided on second end 100d of mattress but it will be understood that the access port could, instead, be provided elsewhere on mattress 100 including but not limited to any other part of the peripheral wall of first end 100c, first side 100e, or second side 100f. Access port 100h could also be provided on one of first wall 100a and second wall 100b but this is less desirable from an aesthetic point of view and from the point of view of the comfort of a person who will use mattress 100h. It will be understood that more than one access port 100h may be provided on mattress 100.

Access port 100h is movable between an open condition and a closed condition. When access port 100h is moved to the open condition, the access port places the interior cavity 100g of mattress 100 in fluid communication with an environment around an exterior surface of the mattress 100. Access port 100h may include a valve to control the flow of air into interior cavity 100g or out of interior cavity 100g through the access port. In one embodiment, a pump may be selectively operatively engaged with access port 100h in order to inflate mattress 100 or to deflate mattress 100 as desired. In other embodiments, a person can manually blow air into interior cavity 100g through access port 100h when moved to the open condition.

In accordance with an aspect of the present disclosure, an interior wall 100j extends between a region of first wall 100a and a region of second wall 100b. The regions of the first wall 100a and second wall 100b are located a distance inwardly from a perimeter of first wall 100a and a perimeter of second wall 100b, respectively. Interior wall 100j bounds and defines a bore 100k which extends through mattress 100 between first wall 100a and second wall 100b. The bore 100k is located generally centrally on mattress 100 as illustrated on the attached figures but it will be understood that bore 100k may be provided in any desired location. Bore 100k extends from a first opening 100k′ in first wall 100a through to a second opening 100k″ in second wall 100b. It should be noted that interior wall 100j forms part of the boundary of interior cavity 100g. As such, interior cavity 100g is bounded and defined by first wall 100a, second wall 100b, first end 100c, second end 100d, first side 100e, second side 100f, and interior wall 100j.

In one embodiment, at least one web 100m (FIG. 9) may be provided within chamber 100g. Each web 100m extends between an interior surface of first wall 100a and an interior surface of second wall 100b and is arranged longitudinally in the illustrated embodiment. The connection between the webs 100m and first and second walls 100a, 100b forms longitudinally-extending reinforced regions 100a′ and 100b′ on first wall 100a and second wall 100b, respectively. Webs 100m effectively divide the interior chamber 100g into separate cells. Webs 100m may terminate in interior wall 100j where the connection between the web 100m and interior wall 100j forms a reinforced region, generally indicated at 100j′ (FIG. 1). However, the webs do not extend across the entire length of the interior chamber between first end 100c and interior wall 100j and between second end 100d and interior wall 100j. Consequently, there is fluid communication between the various cells formed within interior chamber 100g. When air is introduced into interior chamber 100g, through access port 100h, air will flow into each separate cell within the interior chamber 100g, thereby inflating mattress 100. Similarly, when mattress 100 is deflated, air will exit interior chamber 100g via access portion 100h, withdrawing air from each of the separate cells within interior chamber 100g until mattress if fully deflated. The webs 100m and their connection to first wall 100a, second wall 100b, and interior wall 100j provides structural strength and stability to mattress 100.

It should be noted that in addition to the longitudinally-extending webs 100m, there may be laterally-extending webs or other-angled webs extending between first wall 100a and second wall 100b. Any desired arrangement of webs may be provided within interior cavity 100g and therefore any desired arrangement of reinforced regions on first wall 100a, second wall 100b, and interior wall 100j. It should further be noted that in some embodiments of mattress, webs 100m may be entirely omitted.

In accordance with another aspect of the present disclosure, at least one cup holder 100n (FIG. 1) is defined in first wall 100a and, similarly, at least one cup holder 100p (FIG. 2) is defined in second wall 100b. Cup holders 100n, 100p may be provided at any desired and suitable location on first wall 100a and second wall 100b. Each cup holder 100p, 100n comprises a reinforced recess defined within the associated first wall 100a and second wall 100b, respectively, with the mattress material which defines each cup holder effectively extending inwardly into the interior chamber 100g of mattress. Cup holders 100p, 100n are configured to be able to receive most 16 oz cups and are located so as to be easily accessible to a person using mattress 100. The location of cup holders 100p, 100n as illustrated in the figures is exemplary only and should not be considered to limit the possible locations of the cup holders on mattress 100.

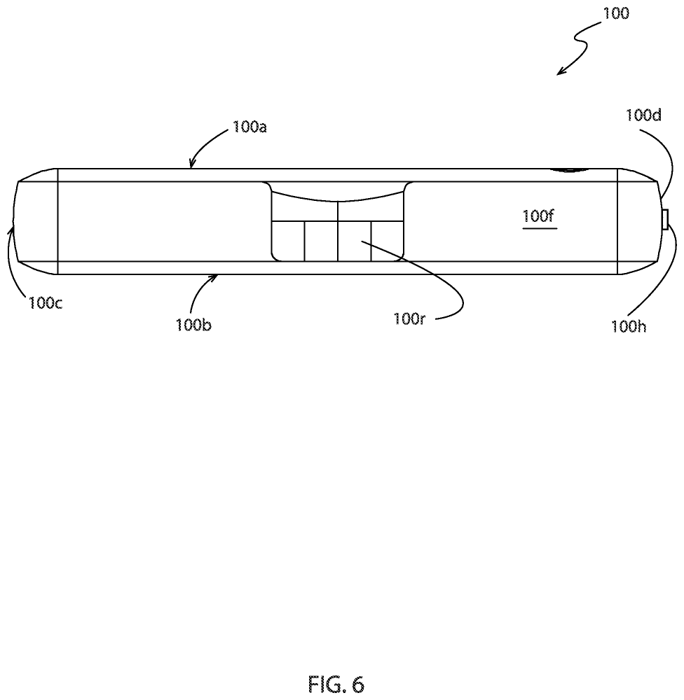

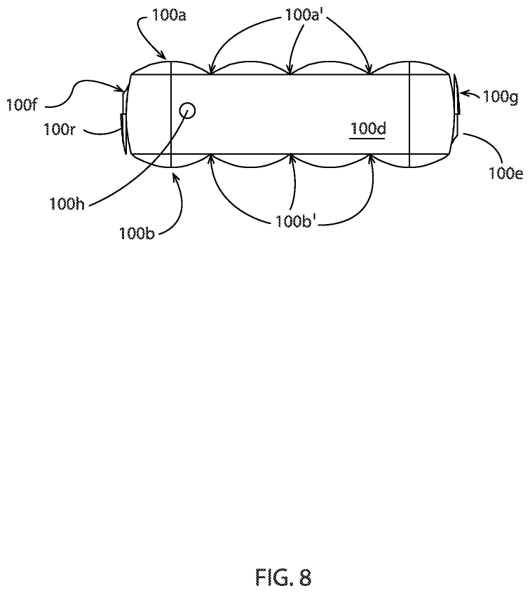

In accordance with yet another aspect of the present disclosure, at least one pocket 100q is provided on an exterior surface of the first side 100e and at least one pocket 100r (FIGS. 3 and 6) is provided on an exterior surface of second side 100f of mattress 100. Pockets 100q and 100r are inverted relative to one another. The term “inverted” is used to describe that an opening (not shown) to the first pocket 100q is accessible from a direction moving from the first wall 100a towards the second wall 100b; and that an opening (not shown) to the second pocket 100r is accessible from a direction moving from the second wall 100b towards the first wall 100a. The inverted nature of pockets 100q and 100r is readily seen in FIGS. 7 and 8. The inverted pockets 100q, 100r are provided so that if a person selects to lay on first wall 100a of mattress 100 they will be able to easily insert objects into or withdraw objects through the opening to first pocket 100q (but not from the opening to second pocket 100r). If, on the other hand, a person selects to lay on second wall 100b of mattress 100, they will be able to easily insert objects into or withdraw objects through the opening to second pocket 100r (but not from first pocket 100q). Pockets 100q, 100r may include one or more separate, smaller pockets suitable for separately receiving and holding objects such as a smartphone, a tablet, a TV controller, books, magazines etc.

In accordance with a further aspect of the present disclosure bore 100j through mattress 100 is generally elliptical in shape when viewed from above and from below. The dimensions of the elliptically-shaped first opening 100k′ to bore 100k defined by first wall 100a differ from the dimensions of the elliptically-shaped second opening 100k″ to bore 100k defined by second wall 100b. In particular, first opening 100k′ is larger than second opening 100k″. In one embodiment and as shown in FIG. 9, the longitudinal dimension of the first opening 100k′ is indicated by the reference character x′ while the longitudinal dimension of the second opening 100k″ is indicated by the reference character x″. As shown in FIG. 10, the lateral dimension of the first opening 100k′ is indicated by the reference character y′ and the lateral dimension of the second opening 100k″ is indicated by the reference character y″. In one embodiment, both longitudinal dimensions x′ and x″ measure about 14 inches, the lateral dimension y′ measures 17.5 inches, and the lateral dimension y″ measures 15 inches. In the first embodiment, the bore 100k of mattress 100 tapers very gradually in longitudinal and lateral dimensions from first opening 100k′ to second opening 100k″.

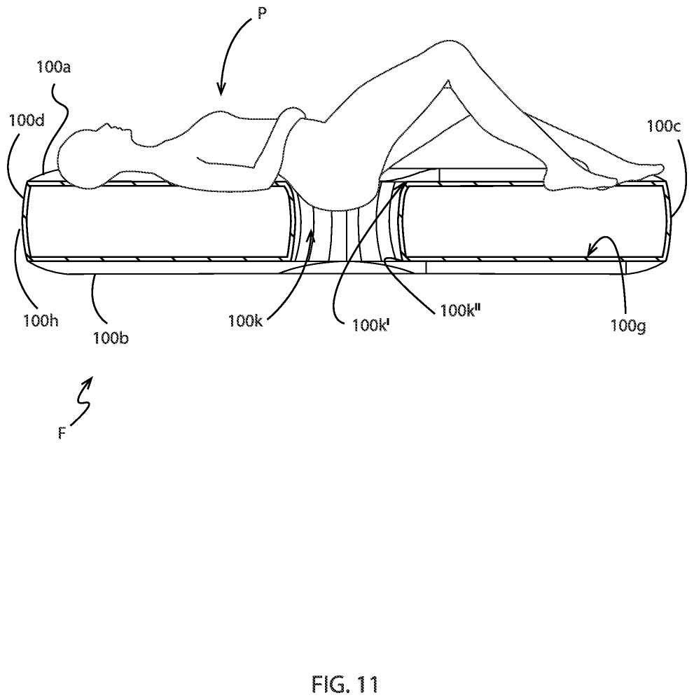

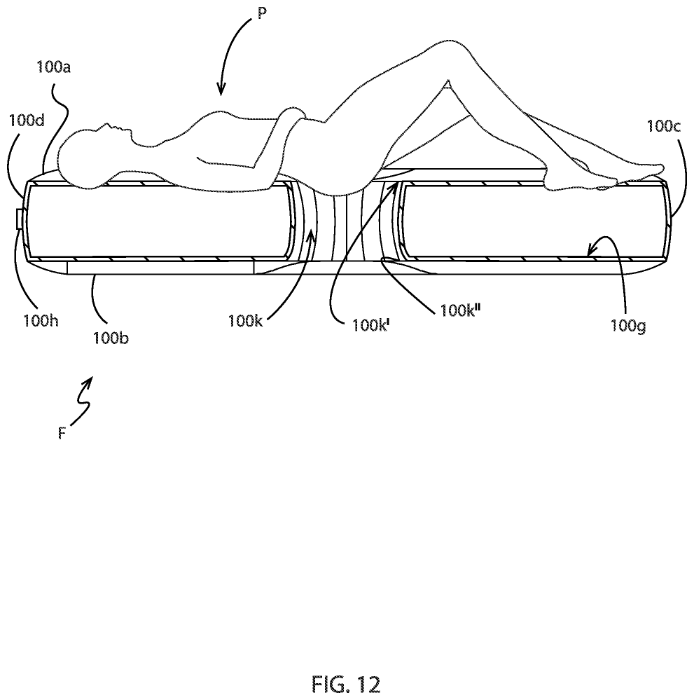

When the mattress 100 is to be used as is illustrated in FIGS. 11 and 12, the person “P” will select whether to face the larger dimensioned first opening 100k′ or the smaller dimensioned second opening 100k″ upwardly. In other words, the person “P” selects whether to place second wall 100b on the floor or first wall 100a on the floor. The selection will be made so that the person's buttocks will be most comfortably supported in the opening to the bore 100j which is facing upwardly. Ideally, the person does not want to have to insert a pillow or cushion into the bore 100j but will rather let the mattress itself support their body. FIG. 11 shows an instance where the person “P” selects to put second wall 100b of mattress 100 on the floor “F” and then lays on the first wall 100a with their buttocks positioned through the first opening 100k′ and into bore 100k. FIG. 12 shows an instance where the person “P” selects to put first wall 100a on the floor “F” and then lays on the second wall 100b with their buttocks positioned through the second opening 100k″ and into bore 100k.

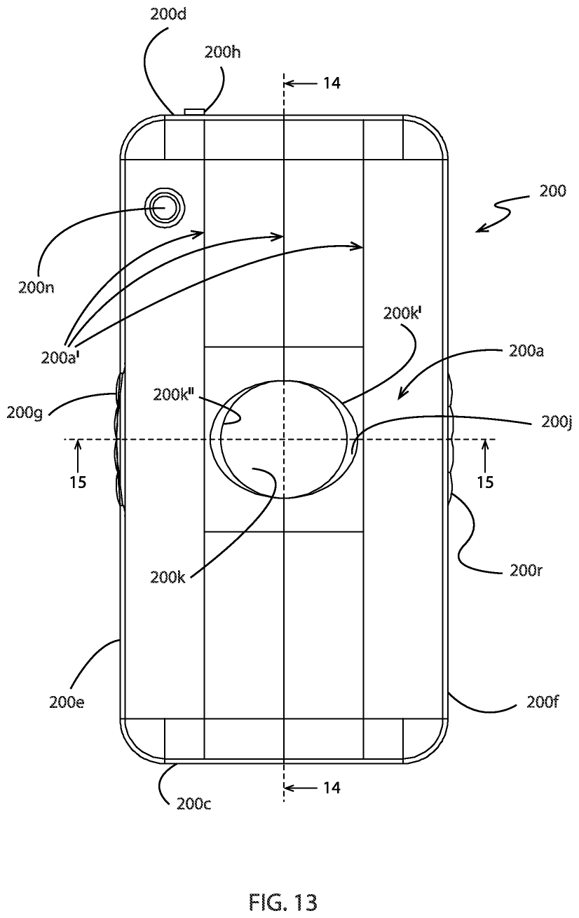

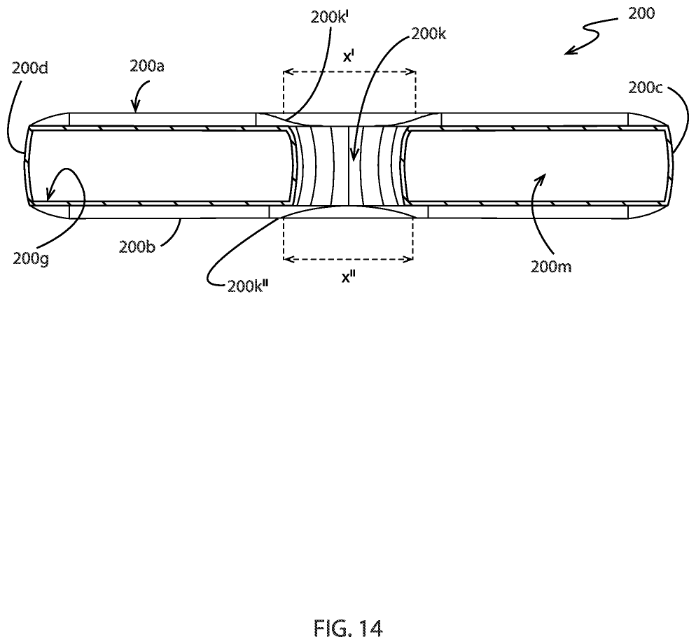

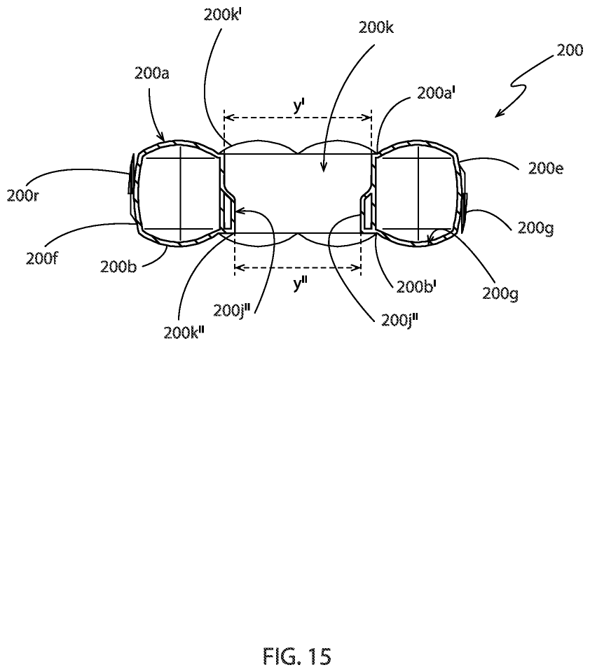

Referring now to FIGS. 13 through 15, there is shown a second embodiment of a mattress in accordance with the present disclosure, generally indicated at 200. Mattress 200 includes a first wall 200a and an opposed second wall 200b, a first end 200c and an opposed second end 200d, a first side 200e and an opposed second side 200f. First wall 200a and second wall 200b define a vertical direction therebetween; first end 200c and second end 200d define a longitudinal direction therebetween, and first side 200e and second side 200f define a lateral or transverse direction therebetween. Referring to FIGS. 14 and 15, first wall 200a, second wall 200b, first end 200c, second end 200d, first side 200e, and second side 200f bound and define an interior chamber 200g (FIG. 14). At least one access port 200h similar to access port 100h is provided on mattress 200 to enable a user to inflate and/or deflate mattress 200. Mattress 200 includes a cup holder 200n (FIG. 13) defined in first wall 200a and a cup holder (not shown) defined in second wall 200b which is substantially identical to cup holder 100p on mattress 100. Mattress 200 further includes pockets 200q and 200r which are substantially similar to pockets 100q and 100r.

In one embodiment, a plurality of webs 200m (FIG. 14) may be provided within chamber 200g. Each web 200m extends between an interior surface of first wall 200a and an interior surface of second wall 200b and is arranged longitudinally in the illustrated embodiment. The connection between the webs 200m and first and second walls 200a, 200b forms longitudinally-extending reinforced regions 200a′ (FIG. 13) on first wall 200a and similar reinforced regions 200b′ (FIG. 15) on second wall 200b. Webs 200m are of the same structure and perform the same function as webs 100m, and may be similarly differently shaped and oriented.

All components of mattress 200 are substantially identical in structure, function, and configuration to those of mattress 100 except for the shape of the bore which extends from first wall 200a through to second wall 200b as will be further discussed below.

Similar to mattress 100, an interior wall 200j is provided on mattress 200 and extending between first wall 200a and second wall 200b. Interior wall 200j bounds and defines a bore 200k which extends through mattress 200 from a first opening 200k′ defined in first wall to a second opening 200k″ defined in second wall 200b. As illustrated on the attached figures, bore 200k is located generally centrally on mattress 200 but it will be understood that bore 200k may be provided in any other desired, suitable location. Bore 200k is generally elliptical in shape when viewed from above or below. Bore 200k extends from a first opening 200k′ in first wall 200a through to a second opening 200k″ in second wall 200b. As best seen in FIG. 15, at least a portion of the interior wall 200j is shaped to form a ledge 200j″ such that a first region of the bore 200k proximate first wall 200a is of a greater circumference than a second region of the bore 200k proximate second wall 200b. The second region of the bore 200k is bounded and defined by the ledge 200j″ of interior wall 200j. Similar to mattress 100, the dimensions of first opening 200k′ of mattress 200 are greater than the dimensions of second opening 200k″. The longitudinal dimension of the first opening 200k′ is indicated by the reference character x′ (FIG. 14) and the longitudinal dimension of the second opening 200k″ is indicated by the reference character x″. As shown in FIG. 15, the lateral dimension of the first opening 200k′ is indicated by the reference character y′ and the lateral dimension of the second opening 200k″ is indicated by the reference character y″. In one embodiment, both longitudinal dimensions x′ and x″ measure about 14 inches, the lateral dimension y′ measures 17.5 inches, and the lateral dimension y″ measures 15 inches. In the second embodiment, the bore 200k of mattress 200 tapers very gradually in longitudinal and lateral dimensions from first opening 200k′ to an uppermost end of ledge 200j″ and is then of a substantially constant diameter from the uppermost end of ledge 200j′ to the second opening 200k″.

Mattress 200 is used in a substantially identical manner to mattress 100. The user will select whether to lay on first wall 200a or on second wall 200b based on the circumference of bore 200j in which to seat their buttocks. In particular, the user will select whether to have the first opening 200k′ or the second opening 200k″ to bore 200j facing upwardly. The ledge 200j″ provides a bit of a natural cushion upon which the person's buttocks are able to rest comfortably.

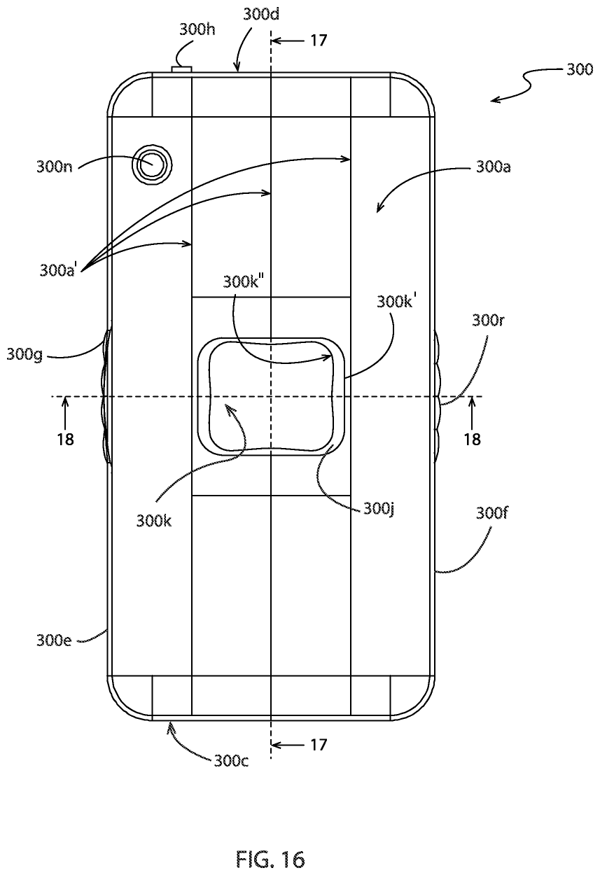

Referring now to FIGS. 16 through 18, there is shown a third embodiment of a mattress in accordance with the present disclosure, generally indicated at 300. Mattress 300 includes a first wall 300a and an opposed second wall 300b, a first end 300c and an opposed second end 300d, a first side 300e and an opposed second side 300f. First wall 300a and second wall 300b define a vertical direction therebetween; first end 300c and second end 300d define a longitudinal direction therebetween, and first side 300e and second side 300f define a lateral or transverse direction therebetween.

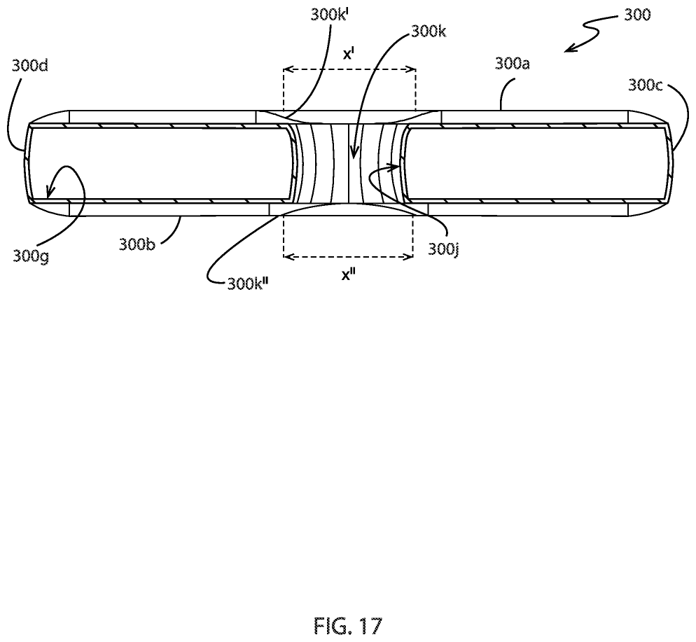

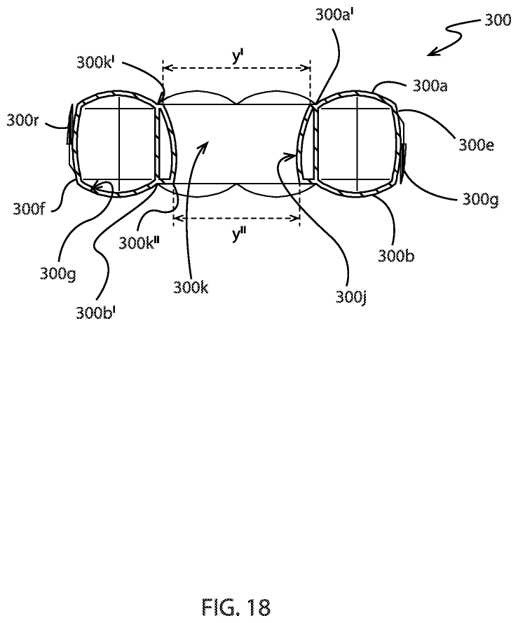

Referring to FIGS. 17 and 18, first wall 300a, second wall 300b, first end 300c, second end 300d, first side 300e, and second side 300f bound and define an interior chamber 300g (FIG. 17). At least one access port 300h similar to access port 100h is provided on mattress 300 to enable a user to inflate and/or deflate mattress 300. Mattress 300 includes a cup holder 300n (FIG. 16) defined in first wall 300a and a cup holder (not shown) defined in second wall 300b which is substantially identical to cup holder 100p on mattress 100. Mattress 300 further includes pockets 300q and 300r which are substantially similar to pockets 100q and 100r.

In one embodiment, a plurality of webs 300m (FIG. 17) may be provided within chamber 300g. Each web 300m extends between an interior surface of first wall 300a and an interior surface of second wall 300b and is arranged longitudinally in the illustrated embodiment. The connection between the webs 300m and first and second walls 300a, 300b forms longitudinally-extending reinforced regions 300a′ (FIG. 16) on first wall 300a and similar reinforced regions 300b′ (FIG. 18) on second wall 300b. Webs 300m are of the same structure and perform the same function as webs 100m, and may be similarly differently shaped and oriented.

All components of mattress 300 are substantially identical in structure, function, and configuration to those of mattress 100 except for the shape of the bore which extends from first wall 300a through to second wall 300b as will be further discussed below.

Similar to mattress 100, an interior wall 300j is provided on mattress 300 and extending between first wall 300a and second wall 300b. Interior wall 300j bounds and defines a bore 300k which extends through mattress 300 from a first opening 300k′ defined in first wall to a second opening 300k″ defined in second wall 300b. As illustrated on the attached figures, bore 300k is located generally centrally on mattress 300 but it will be understood that bore 300k may be provided in any other desired, suitable location. Bore 300k is generally rectangular in shape when viewed from above or below. Bore 300k extends from a first opening 300k′ in first wall 300a through to a second opening 300k″ in second wall 300b. As best seen in FIG. 18, a first region of the bore 300k proximate first wall 300a is of a greater circumference than a second region of the bore 300k proximate second wall 300b. Similar to mattress 100, the dimensions of first opening 300k′ of mattress 300 are greater than the dimensions of second opening 300k″. The longitudinal dimension of the first opening 300k′ is indicated by the reference character x′ (FIG. 17) and the longitudinal dimension of the second opening 300k″ is indicated by the reference character x″. As shown in FIG. 18, the lateral dimension of the first opening 300k′ is indicated by the reference character y′ and the lateral dimension of the second opening 300k″ is indicated by the reference character y″. In one embodiment, both longitudinal dimensions x′ and x″ measure about 14 inches, the lateral dimension y′ measures 17.5 inches, and the lateral dimension y″ measures 15 inches. In the third embodiment, the bore 300k of mattress 300 tapers very gradually in longitudinal and lateral dimensions from first opening 300k′ to second opening 300k″.

Mattress 300 is used in a substantially identical manner to mattress 100. The user will select whether to lay on first wall 300a or on second wall 300b based on the circumference of bore 300j in which to seat their buttocks. In particular, the user will select whether to have the first opening 300k′ or the second opening 300k″ to bore 300j facing upwardly.

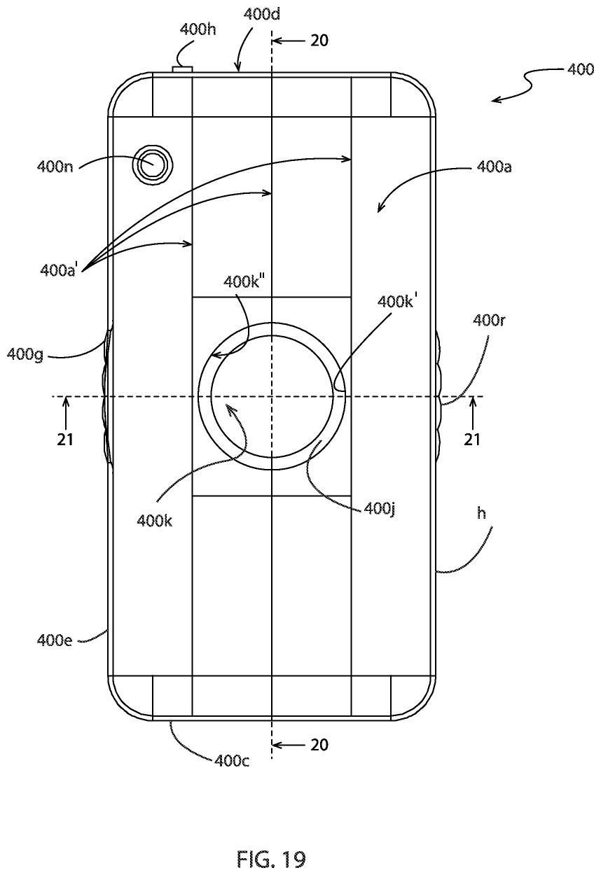

Referring now to FIGS. 19 through 21, there is shown a fourth embodiment of a mattress in accordance with the present disclosure, generally indicated at 400. Mattress 400 includes a first wall 400a and an opposed second wall 400b, a first end 400c and an opposed second end 400d, a first side 400e and an opposed second side 400f. First wall 400a and second wall 400b define a vertical direction therebetween; first end 400c and second end 400d define a longitudinal direction therebetween, and first side 400e and second side 400f define a lateral or transverse direction therebetween.

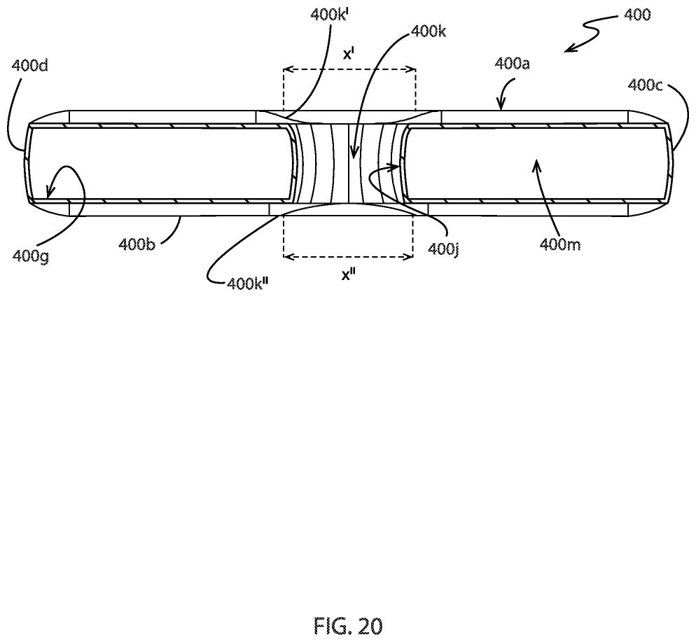

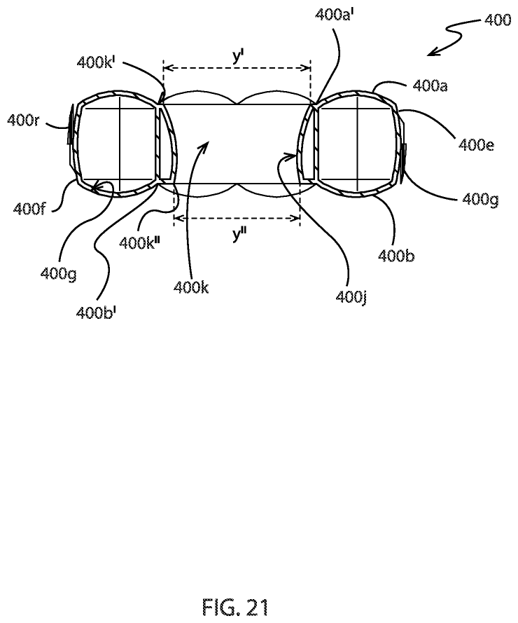

Referring to FIGS. 20 and 21, first wall 400a, second wall 400b, first end 400c, second end 400d, first side 400e, and second side 400f bound and define an interior chamber 400g (FIG. 20). At least one access port 400h similar to access port 100h is provided on mattress 400 to enable a user to inflate and/or deflate mattress 400. Mattress 400 includes a cup holder 400n (FIG. 19) defined in first wall 400a and a cup holder (not shown) defined in second wall 400b. The cup holder in second wall 400b is substantially identical to cup holder 100p on mattress 100. Mattress 400 further includes pockets 400q and 400r which are substantially similar to pockets 100q and 100r.

In one embodiment, a plurality of webs 400m (FIG. 20) may be provided within chamber 400g. Each web 400m extends between an interior surface of first wall 400a and an interior surface of second wall 400b and is arranged longitudinally in the illustrated embodiment. The connection between the webs 400m and first and second walls 400a, 400b forms longitudinally-extending reinforced regions 400a′ (FIG. 19) on first wall 400a and similar reinforced regions 400b′ (FIG. 21) on second wall 400b. Webs 400m are of the same structure and perform the same function as webs 100m, and may be similarly differently shaped and oriented.

All components of mattress 400 are substantially identical in structure, function, and configuration to those of mattress 100 except for the shape of the bore which extends from first wall 400a through to second wall 400b as will be further discussed below.

Similar to mattress 100, an interior wall 400j is provided on mattress 400 and extending between first wall 400a and second wall 400b. Interior wall 400j bounds and defines a bore 400k which extends through mattress 400 from a first opening 400k′ defined in first wall to a second opening 400k″ defined in second wall 400b. As illustrated on the attached figures, bore 400k is located generally centrally on mattress 400 but it will be understood that bore 400k may be provided in any other desired, suitable location. Bore 400k is generally circular in shape when viewed from above or below. Bore 400k extends from a first opening 400k′ in first wall 400a through to a second opening 400k″ in second wall 400b.

As best seen in FIG. 21, a first region of the bore 400k proximate first wall 400a is of a greater circumference than a second region of the bore 400k proximate second wall 400b. Similar to mattress 100, the dimensions of first opening 400k′ of mattress 400 are greater than the dimensions of second opening 400k″. The longitudinal dimension of the first opening 400k′ is indicated by the reference character x′ (FIG. 20) and the longitudinal dimension of the second opening 400k″ is indicated by the reference character x″. As shown in FIG. 21, the lateral dimension of the first opening 400k′ is indicated by the reference character y′ and the lateral dimension of the second opening 400k″ is indicated by the reference character y″. In one embodiment, both longitudinal dimensions x′ and x″ measure about 14 inches, the lateral dimension y′ measures 17.5 inches, and the lateral dimension y″ measures 15 inches. In the third embodiment, the bore 400k of mattress 400 tapers very gradually in longitudinal and lateral dimensions from first opening 400k′ to second opening 400k″.

Mattress 400 is used in a substantially identical manner to mattress 100. The user will select whether to lay on first wall 400a or on second wall 400b based on the circumference of bore 400j in which to seat their buttocks. In particular, the user will select whether to have the first opening 400k′ or the second opening 400k″ to bore 400j facing upwardly.

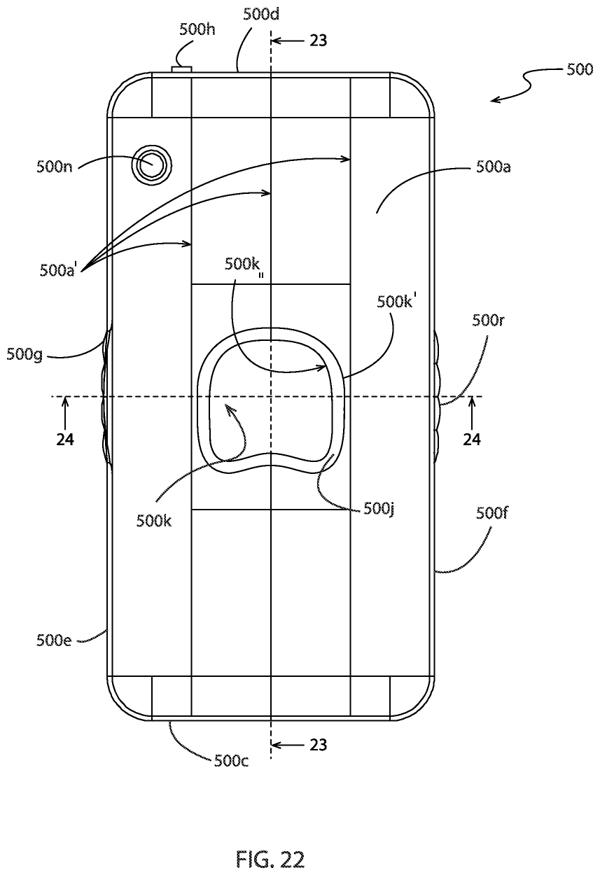

Referring now to FIGS. 22 through 24, there is shown a fifth embodiment of a mattress in accordance with the present disclosure, generally indicated at 500. Mattress 500 includes a first wall 500a and an opposed second wall 500b, a first end 500c and an opposed second end 500d, a first side 500e and an opposed second side 500f. First wall 500a and second wall 500b define a vertical direction therebetween; first end 500c and second end 500d define a longitudinal direction therebetween, and first side 500e and second side 500f define a lateral or transverse direction therebetween.

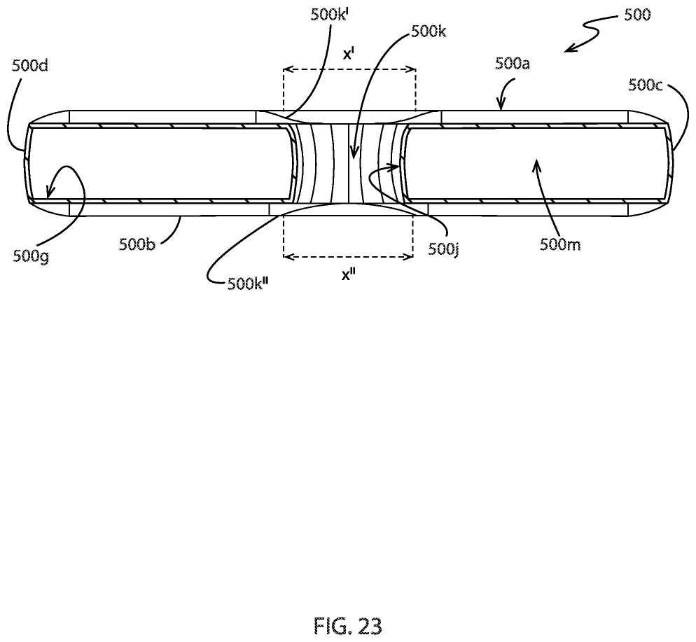

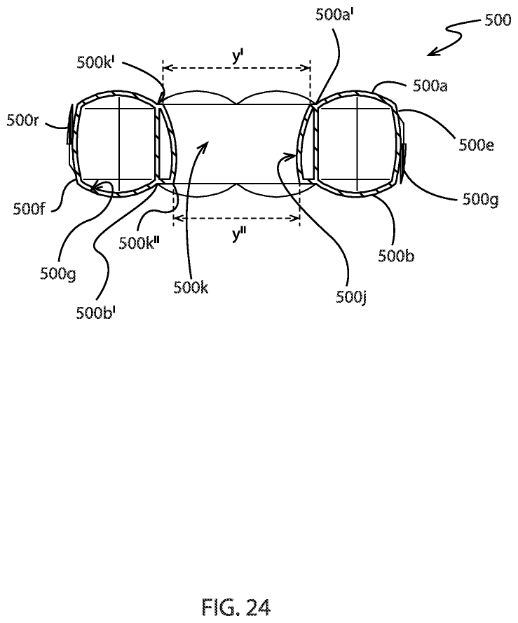

Referring to FIGS. 23 and 24, first wall 500a, second wall 500b, first end 500c, second end 500d, first side 500e, and second side 500f bound and define an interior chamber 500g (FIG. 23). At least one access port 500h similar to access port 100h is provided on mattress 500 to enable a user to inflate and/or deflate mattress 500. Mattress 500 includes a cup holder 500n (FIG. 22) defined in first wall 500a and a cup holder (not shown) defined in second wall 500b. The cup holder in second wall 500b is substantially identical to cup holder 100p on mattress 100. Mattress 500 further includes pockets 500q and 500r which are substantially similar to pockets 100q and 100r.

In one embodiment, a plurality of webs 500m (FIG. 23) may be provided within chamber 500g. Each web 500m extends between an interior surface of first wall 500a and an interior surface of second wall 500b and is arranged longitudinally in the illustrated embodiment. The connection between the webs 500m and first and second walls 500a, 500b forms longitudinally-extending reinforced regions 500a′ (FIG. 22) on first wall 500a and similar reinforced regions 500b′ (FIG. 24) on second wall 500b. Webs 500m are of the same structure and perform the same function as webs 100m, and may be similarly differently shaped and oriented.

All components of mattress 500 are substantially identical in structure, function, and configuration to those of mattress 100 except for the shape of the bore which extends from first wall 500a through to second wall 500b as will be further discussed below.

Similar to mattress 100, an interior wall 500j is provided on mattress 500 and extending between first wall 500a and second wall 500b. Interior wall 500j bounds and defines a bore 500k which extends through mattress 500 from a first opening 500k′ defined in first wall to a second opening 500k″ defined in second wall 500b. As illustrated on the attached figures, bore 500k is located generally centrally on mattress 500 but it will be understood that bore 500k may be provided in any other desired, suitable location. Bore 500k is generally square in shape when viewed from above or below. In the illustrated embodiment, a region of interior wall 500j which is located proximate first end 500c is convexly curved and extends for a distance into the bore 200k. Bore 500k extends from a first opening 500k′ in first wall 500a through to a second opening 500k″ in second wall 500b.

As best seen in FIG. 23, a first region of the bore 500k proximate first wall 500a is of greater dimensions than a second region of the bore 500k proximate second wall 500b. Similar to mattress 100, the dimensions of first opening 500k′ of mattress 500 are greater than the dimensions of second opening 500k″. The longitudinal dimension of the first opening 500k′ is indicated by the reference character x′ (FIG. 23) and the longitudinal dimension of the second opening 500k″ is indicated by the reference character x″. As shown in FIG. 24, the lateral dimension of the first opening 500k′ is indicated by the reference character y′ and the lateral dimension of the second opening 500k″ is indicated by the reference character y″. In one embodiment, both longitudinal dimensions x′ and x″ measure about 14 inches, the lateral dimension y′ measures 17.5 inches, and the lateral dimension y″ measures 15 inches. In the third embodiment, the bore 500k of mattress 500 tapers very gradually in longitudinal and lateral dimensions from first opening 500k′ to second opening 500k″.

Mattress 500 is used in a substantially identical manner to mattress 100. The user will select whether to lay on first wall 500a or on second wall 500b based on the circumference of bore 500j in which to seat their buttocks. In particular, the user will select whether to have the first opening 500k′ or the second opening 500k″ to bore 500j facing upwardly.

It should be noted that while the mattress in accordance with the present disclosure is inflatable, in other embodiments the mattress may be fabricated from a material that is substantially solid. In other words, the mattress may not define an interior chamber into which air is pumped in order for the mattress to keep its shape. For example, the mattress may be a foam mattress. In these instances the mattress will not define an interior chamber and will not have an access port. All other features of the substantially solid mattress will be the same as the inflatable version of the mattress.

It will be understood that while the first opening to the bore and the second opening to the bore in each of the embodiments of the mattress disclosed herein are illustrated as being of substantially a same shape, e.g. both elliptical in shape, or rectangular or circular, it will be understood that in other embodiments (not shown herein) the two openings may be different in shape. For example, the first opening may be elliptical and the second opening may be circular or rectangular, or vice versa. Additionally, while a ledge has only been disclosed in the second embodiment, similar ledges may be provided in any of the third embodiment, fourth embodiment, or fifth embodiment of the mattress disclosed herein.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A mattress for recovery after surgery, said mattress comprising:
A first wall and an opposed second wall spaced from the first wall;
A peripheral wall extending between the first wall and the second wall;
An interior wall extending between a region of the first wall and a region of the second wall, wherein the interior wall is spaced inwardly from the peripheral wall;
A bore bounded and defined by the interior wall;
A first opening to the bore defined in the first wall;
A second opening to the bore defined in the second wall; and
Wherein the first opening is of a first dimension and the second opening is of a second dimension, and the second dimension differs from the first dimension.

2. The mattress according to claim 1, wherein the first opening is larger than the second opening.

3. The mattress according to claim 1, wherein the bore is generally elliptical in shape when viewed from above or from below.

4. The mattress according to claim 1, wherein the bore is generally rectangular in shape when viewed from above or from below.

5. The mattress according to claim 1, wherein the bore is generally circular in shape when viewed from above or from below.

6. The mattress according to claim 1, wherein the bore is generally square in shape when viewed from above or from below.

7. The mattress according to claim 1, further comprising a cup holder defined in the first wall.

8. The mattress according to claim 1, further comprising a cup holder defined in the second wall.

9. The mattress according to claim 1, wherein the peripheral wall includes a first side and an opposed second side which define a lateral direction therebetween; and wherein the mattress further comprises a first pocket provided on an exterior surface of the first side.

10. The mattress according to claim 9, further comprising a second pocket provided on an exterior surface of the second side.

11. The mattress according to claim 10, wherein the second pocket is inverted relative to the first pocket.

12. The mattress according to claim 10, wherein an opening to the first pocket is accessible from a direction moving from the first wall towards the second wall.

13. The mattress according to claim 10, wherein an opening to the second pocket is accessible from a direction moving from the second wall towards the first wall.

14. The mattress according to claim 1, wherein the first wall, the second wall, the peripheral wall, and the interior wall bound and define an interior chamber.

15. The mattress according to claim 14, further comprising an access port defined in the peripheral wall, said access port being movable between an open condition and a closed condition; and wherein when the access port is in an open condition the access port places the interior chamber in fluid communication with the environment around an exterior of the mattress.

16. The mattress according to claim 1, wherein the mattress is inflatable.

17. The mattress according to claim 1, wherein the mattress is fabricated from Polyvinyl Chloride.

18. The mattress according to claim 1, further comprising flocking provided on an exterior surface of at least the first wall and the second wall.

19. The mattress according to claim 1, further comprising a web extending between an interior surface of the first wall and an interior surface of the second wall.

20. The mattress according to claim 1, wherein the mattress is movable between a collapsed condition and an expanded condition, wherein in the collapsed condition an interior surface of the first wall is adjacent an interior surface of the second wall; and wherein the expanded condition, the interior surface of the first wall is remote from the interior surface of the second wall.
